(19) United States
(12) Patent Application Publication
(10) Pub. No.: US 2009/0099772 A1
(43) Pub. Date: Apr. 16, 2009

(54) Augmented navigation system and method of a moving object

(75) Inventors: Di Chiu, Taipei County (TW); Yuan Yu Chou, Taoyuan County (TW); Feng Tyan, Taoyuan County (TW)

Correspondence Address: CHARLES E. BAXLEY, ESQUIRE, 90 JOHN STREET, SUITE 309, NEW YORK, NY, 10038, US

(73) Assignees: Di Chiu (Owners in Common 1/2); GRT Technology Co., Ltd. (Owners in Common 1/2)

(21) Appl. No.: 12/231,272

(22) Filed: Aug. 28, 2008

(30) Foreign Application Priority Data
Oct. 12, 2007 (TW) 096138122

(51) Int. Cl. G01C 21/00; G01C 21/16

(52) U.S. Cl. 701/213; 701/220

(57) ABSTRACT

In an augmented navigation method of a moving object, an error model capable of outputting calibrated data is created according to global positioning system (GPS) data and inertial detecting data when an object is moving. When the moving object enters an invisible region, the calibrated data and the inertial detecting data are combined together to generate an estimated position. In order to achieve the method, an augmented navigation system is provided. The augmented navigation system includes a front platform for receiving the GPS data and generating the inertial detecting data. The GPS data and the inertial detecting data may be transmitted to a rear platform through a wireless network. The error model is disposed on the front platform or the rear platform, and the rear platform has an estimator capable of combining the calibrated data outputted from the error model with the inertial detecting data to generate the estimated position.

### BACKGROUND OF THE INVENTION

1. Field of the Invention

The invention relates to a navigation method and a navigation system, and more particularly to a navigation method and a navigation system capable of precisely positioning a moving object, which enters an invisible region.

2. Description of the Related Art

A global positioning system (GPS) is a known navigation system capable of precisely positioning a moving object in a region where satellite signals can reach. However, in another region, such as a basement or a tunnel, where the satellite signals cannot reach, or the satellite signals are interfered and shielded, the GPS fails and cannot position the object.

An inertial navigation system (INS) is another known navigation system, which allows automatic operations and is free from being influenced by the geography. After the start-point position is initialized, the inertial navigation system can output messages, such as a position, a speed and a direction of the moving object. However, its navigation solution drifts with time such that the navigation error is enlarged.

Thus, the GPS and the INS may be combined together to form a hybrid navigation system so that the navigation error of the GPS can be compensated according to the short-time navigation precision of the INS, and the navigation error of the INS ascending with time can be compensated by the long-time navigation precision of the GPS.

Taiwan Patent No. 489212 (U.S. Pat. No. 6,167,347) discloses a vehicle positioning and navigating method using a global positioning system (GPS), an inertial measurement unit (IMU) and a Kalman filter for combining the signals of the GPS and the IMU to enhance the precision of the hybrid positioning and navigating system. In addition, the IMU can be used to compensate for the satellite signal loss. In other words, the IMU signal is for enhancing or supplementing the GPS signal. Thus, the positioning and navigating method of this patent only still can be used in a region where the satellite signals can reach.

U.S. Pat. No. 7,117,087 provides a method for estimating a position of a moving object in a navigation system. When the moving object is located in an invisible region, the straight line distance is calculated according to the displacement amount per unit time and the direction, and then mapped to a map so that the position of the moving object can be determined. However, when the speed and the direction of the moving object change significantly, the estimated position has the great error.

Taiwan Patent No. I284193 discloses a vehicle navigation system and a calibrating method thereof, in which the GPS mainly serves as the navigation reference, a gyroscope is used to get a moving direction and an angle of the vehicle, and an electronic map is also used so that the vehicle's position is determined and the GPS navigation error can be calibrated. However, this patent does not disclose how to position and navigate the vehicle when the GPS signals disappear.

Taiwan Patent No. I250302 discloses an angle calibrating method and an angle calibrating device for a navigation apparatus, in which an electronic compass detects the angle calibrated data to calibrate the angle of the GPS data according to the speed of a moving object so that the navigation precision is enhanced. However, this patent does not teach how to position and navigate in a region where the GPS signals cannot reach.

U.S. Pat. No. 6,826,477 discloses a pedestrian navigation method and a pedestrian navigation apparatus, in which a physiological characteristics state of a pedestrian is inputted to form a step model, and then an inertial detection device is used to detect the accelerations in various directions and the directions of the pedestrian. In addition, the GPS detects the position of the pedestrian, and various pieces of data are inputted into the step model so that the position, speed and direction of the pedestrian are estimated. The estimated data of the step model and the observed data of the GPS can be combined by a Kalman filter. However, this patent does not teach how to perform the positioning and navigating process in a region where the GPS signals cannot reach.

### SUMMARY OF THE INVENTION

Because the prior art cannot have the positioning and navigating function or has the poor navigating and positioning precision without the GPS signals, the invention provides a novel method and a novel system to solve the conventional drawbacks.

An object of the invention is to provide an augmented navigation system of a moving object and a method thereof. The system has a front platform for providing GPS data and inertial detecting data, a rear platform having an estimator for combining and estimating the data, a wireless network for transferring the data of the front platform to the rear platform, and an error model, disposed in the front platform or the rear platform, for reading the GPS data and the inertial detecting data and thus creating a mathematical model. When the moving object enters an invisible region, initial data or input data is inputted to the error model so that calibrated data is generated. The calibrated data is inputted to the estimator and then combined with the inertial detecting data so that an estimated position corresponding to a position and a moving state of the moving object in the invisible region is generated.

Further benefits and advantages of the present invention will become apparent after a careful reading of the detailed description with appropriate reference to the accompanying drawings.

### BRIEF DESCRIPTION OF THE DRAWINGS

The above and other objects of the present invention will become readily apparent by reference to the following detailed description when considered in conjunction with the accompanying drawings.

FIG. 1 is a schematic illustration showing a navigation system according to the invention.

FIG. 2 is a schematic illustration showing another navigation system according to the invention.

FIG. 3A is a schematic illustration showing a position and a moving state of a moving object in a visible region according to the navigation system of the invention.

FIG. 3B is a schematic illustration showing a position and a moving state of the moving object in an invisible region according to the navigation system of the invention.

FIG. 4 is a flow chart showing a navigation method according to the invention.

### DETAILED DESCRIPTION OF THE INVENTION

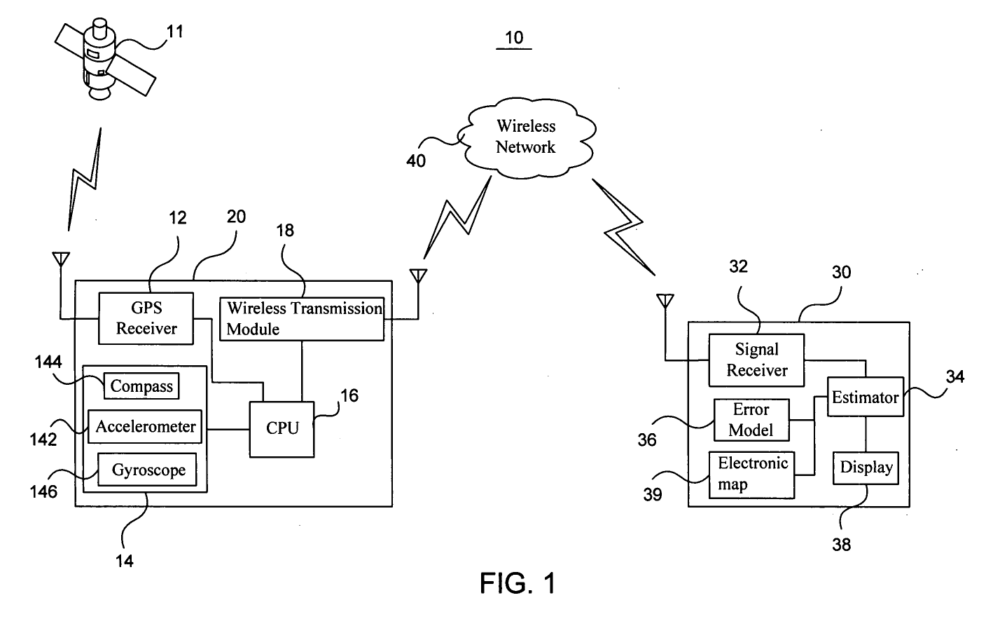

Referring to FIG. 1, a navigation system 10 includes a global positioning system (GPS) receiver 12 for receiving position data transmitted from at least one satellite 11, and an inertial detection device 14 for detecting a speed, a distance, a direction and an angle of a moving object. The moving object includes, without limitation to, a moving vehicle, moving goods or a moving pedestrian.

The GPS receiver 12 and the inertial detection device 14 are connected to a central processing unit (CPU) 16. The data received by the GPS receiver 12 and the data detected by the inertial detection device 14 are transmitted to the CPU 16. The inertial detection device 14 may include an accelerometer 142, an electronic compass 144 and a gyroscope 146.

A wireless transmission module 18 connected to the CPU 16 is for transmitting the GPS data and the data detected by the accelerometer 142, the compass 144 and the gyroscope 146.

The GPS receiver 12, the inertial detection device 14, the CPU 16 and the wireless transmission module 18 are disposed in a portable apparatus or a fixed apparatus, which is defined as a front platform 20.

A rear platform 30 includes a signal receiver 32 for receiving a message coming from the front platform 20, and an error model 36, which is connected to the signal receiver 32 and can read the message outputted from the front platform 20 as reference data.

The error model 36 obtains the acceleration and the orientation angle of the moving object according to the data detected by the accelerometer, the gyroscope and the electronic compass. Then, the information of the acceleration and the orientation angle can be converted into the information of the speed and the displacement by performing the discrete mathematical accumulation or integration operation twice.

The relative speed, orientation angle and position obtained at one observing point when the rear platform 30 performs the calculation are associated with the position of the observing point. The time intervals between neighboring two observing points may be set to be the same. For example, the duration of the operation time may be the fixed reference time (about 1 second) calculated by the GPS. At the same time instant, the relative speed, orientation angle and position determined by the rear platform 30 are compared with the present absolute position, speed and orientation angle, which are calculated by the GPS sensor under the previous condition with the good signal receiving quality, and then an error calibrated amount is generated. Then, a sensor average error offset (ΔXₙ) can be further obtained through the statistical analysis model.

When the GPS receiver enters a region with the weak signal or without the signal, the rear platform 30 generates the sensor average error offset (ΔXₙ) with the data received by the accelerometer 142, the gyroscope 146 and the electronic compass 144 of the inertial detection device 14 serving as initial data or input data, which is inputted to the error model 36. The sensor average error offset and the initial data or the input data are then inputted to an estimator (e.g., EKF, Kalman filter, H_infinity filter, unscented filter, particle filter, or the like) 34 for the mathematical calculation. The path representing technique works with the path-locked function built in the map data, the drifting position can be calibrated so that the precisely positioning effect can be achieved.

It is to be noted that when the message of the front platform 20 includes the GPS data and the data detected by the inertial detection device 14, it represents that the moving object is in a visible region where the GPS can work. At this time, the error model 36 analyzes the data and creates the mathematical model but does not output the sensor average error offset (ΔXₙ).

The estimator 34 is connected to the signal receiver 32 and the error model 36. The signal receiver 32 and the error model 36 respectively transmit the output message of the front platform 20 and the sensor average error offset (ΔXₙ) to the estimator 34, and the pieces of data are combined in the estimator 34 so that an estimated position is generated. A display 38 is connected to the estimator 34 and cooperates with an electronic map 39 to display the position and the moving track of the moving object.

A wireless network 40 is disposed between the front platform 20 and the rear platform 30, and the output message of the front platform 20 can be transmitted to the rear platform 30 via the wireless network 40. The wireless network 40 may be a GSM (Global System for Mobile Communication) network, a GPRS (General Packet Radio Service) network, a Zigbee network, a Bluetooth network, or combinations thereof.

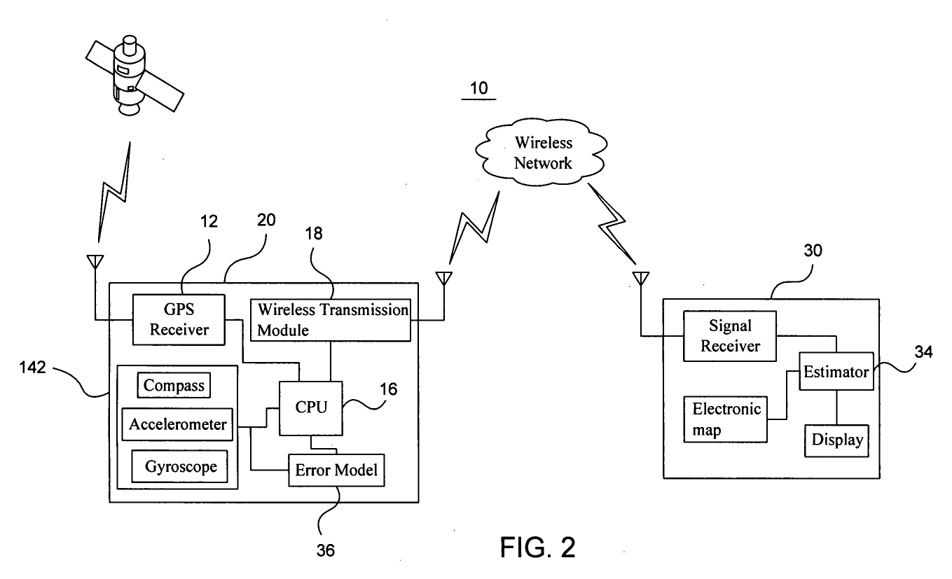

As shown in FIG. 2, this embodiment differs from the previous embodiment in that the error model 36 is disposed in the front platform 20.

The error model 36 receives the positioning data of the GPS receiver 12 and the detected data of the inertial detection device 14, and thus generates a mathematical model according to the pieces of data.

When only the inertial detection device 14 transmits the detected data to the error model 36, the error model 36 generates and outputs a sensor average error offset (ΔXₙ). The detected data and the estimated calibrated data of the inertial detection device 14 are transmitted to the rear platform 30 via the wireless transmission module 18 and the wireless network 40. The estimator 34 receives the pieces of data and then combines and calculates the pieces of data to generate an estimated position.

The estimator 34 mentioned hereinabove may be hardware, software or firmware for combining the pieces of data using a Kalman filter. The rear platform 30 may be a personal computer (PC) or a server.

The position and the moving track of the moving object in the invisible region are estimated according to the following principles.

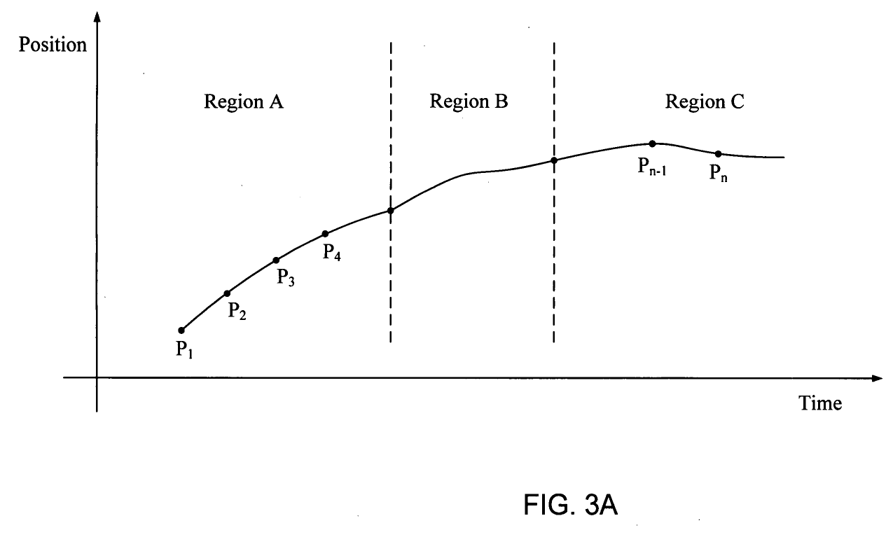

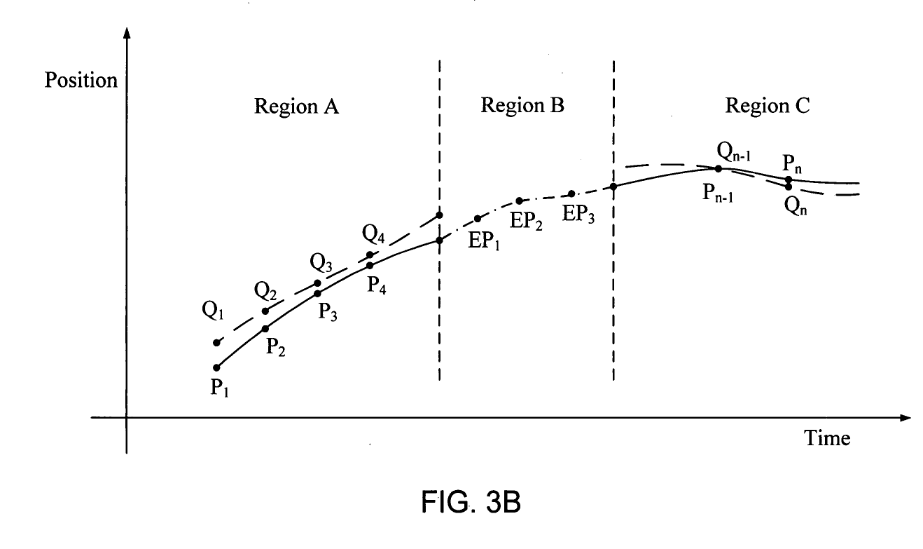

As shown in FIG. 3A, an absolute position and a moving track of a moving object is positioned by the GPS with P₁, P₂, P₃, . . . and Pₙ, for example. In the visible regions, such as the regions A and C, the positioning and moving data of the GPS can be obviously displayed. In the invisible region, such as the region B, it is displayed as a blanking region because the positioning data of the GPS cannot be obtained.

As shown in FIG. 3B, the descriptions (P₁, P₂, P₃, . . . Pₙ) of an absolute position and a moving track of a moving object are made by the GPS, and the descriptions (Q₁, Q₂, Q₃, . . . Qₙ) of the relative position and the moving track are also made by the inertial detection device. In the regions A and C, the GPS data and the detected data of the inertial detection device are included, so two different but similar curves are shown, and the corresponding pieces of data (points) need not to be overlapped. This is because that the detected data of the inertial detection device may generate the deviation amount. In other words, an error offset (ΔX) exists between the GPS data and the inertial detecting data at each detected position, and the following equation is satisfied:

P=Q+66 X (1).

In the region B, the GPS data cannot be obtained, but the inertial detection device still can provide the detected data according to its detecting function. Thus, the sensor average error offset (ΔXₙ) is generated according to the detected data of the inertial detection device and the error model, and is substituted into the equation (1) to generate an estimated position (EP) represented by:

EPₙ=Qₙ+ΔXₙ (2),

wherein n denotes the estimated order generated in the invisible region and n≧1, and ΔX₁ denotes the sensor average error offset generated when the last piece of GPS data and the last piece of inertial detecting data, which are obtained before the moving object enters the invisible region, serve as initial data inputted to the error model. When n≧2, EPₙ₋₁ and Qₙ serve as the input data to be inputted to the error model so that ΔXₙ is generated. The method of creating the error model has been mentioned hereinabove.

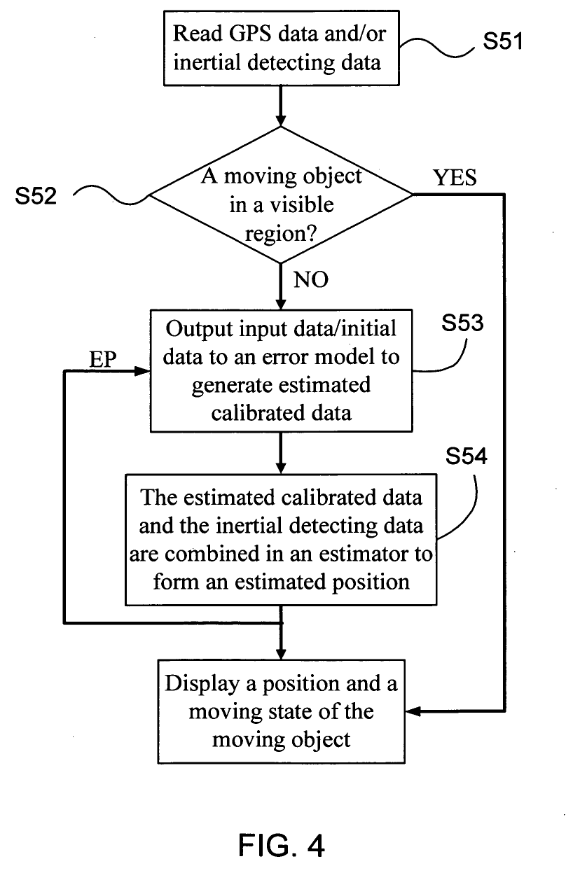

Referring to FIG. 4, the positioning and navigating method of the moving object includes the following steps.

In step S51, the GPS data and the inertial detecting data are read. The GPS data includes the observed position data of the moving object and the observed data of the moving state. The inertial detecting data includes the position, the direction, the speed and the acceleration of the moving object, and the inertial detecting data can be noise-filtered, gain-calibrated and digitalized by a raw data processing procedure.

In step S52, a region wherein the moving object is located is determined. If the GPS data and the inertial detecting data can be read, it is determined that the moving object is in a visible region. Consequently, the rear platform can display the position and the moving track of the moving object according to the GPS data. If the inertial detecting data only can be read, it is determined that the moving object is in an invisible region, and then the procedure enters step S53.

In the step S53, estimated calibrated data is generated. The last GPS data and the inertial detecting data before the moving object enters the invisible region serve as the input data/initial data, and the input data/initial data is inputted to the error model and then calculated to generate a sensor average error offset Δ Xₙ.

In step S54, the position and the moving track of the moving object in the invisible region are estimated. The inertial detecting data and the estimated calibrated data are combined in an estimator to form an estimated position (EP), which may be displayed on a display.

In addition, if the system of the invention only still can read the inertial detecting data with the extension of time, it represents that the moving object does not leave the invisible region. The estimated position (EP) serves as the input data in the step S53 and the next estimated position is generated by the calculation of the error model. The procedure is repeated until the moving object leaves the invisible region. Therefore, when the moving object is in the invisible region, this system can generate a plurality of estimated positions to represent the positions and the moving track of the moving object.

Because the system and the method of the invention can display the positions and the moving state of the moving object being tracked in the invisible region without the GPS signals. Therefore, the invention has the augmented positioning and navigating function and may be applied in conjunction with a hand-held apparatus to serve as a navigator for a traveler, a climber or a rescuer, or serve as a vehicle navigator in conjunction with an electronic map. When the wireless network is added, the vehicle can be tracked and monitored. In addition, a memory can be added to serve as a driving recorder.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An augmented navigation method for displaying a position and a moving track of a moving object in an invisible region, the method comprising the steps of:
reading global positioning system (GPS) data, which comprises observed position data of the moving object;
reading inertial detecting data, which comprises a position, a speed and observed orientation data of the moving object;
creating an error model according to the GPS data and the inertial detecting data in conjunction with a discrete mathematical accumulation and/or an integration operation;
inputting initial data, which comprises the last GPS data and the last inertial detecting data when the moving object enters the invisible region, to the error model to generate and output a first sensor average error offset ΔX₁; and
combining the first sensor average error offset ΔX₁ with first inertial detecting data Q₁ generated when the moving object enters the invisible region to form a first estimated position EP₁ corresponding to the position and the moving track of the moving object.

2. The method according to claim 1, wherein the inertial detecting data is introduced into a raw data processing procedure for noise filtering and data digitizing.

3. The method according to claim 1, wherein data of an (n−1)^{th} estimated position EPₙ₋₁ and an n^{th} inertial detecting data Qn serve as input data, and the input data is inputted to the error model so that an n^{th} sensor average error offset ΔXₙ is generated, and then Qₙ and ΔXₙ are combined together to generate an n^{th} estimated position EPₙ, wherein n≧2.

4. The method according to claim 1, wherein the sensor average error offset generated by the error model comprises a displacement amount and a direction.

5. An augmented navigation system for displaying a position and a moving track of a moving object, the system comprising:
a front platform, which is disposed in the moving object and has a central processing unit (CPU), a global positioning system (GPS) receiver and an inertial detection device connected to the CPU, and a wireless transmission module connected to the CPU;
a rear platform having a signal receiver and a display both connected to an estimator, wherein the signal receiver receives an output signal of the front platform, the estimator processes an output message from the front platform, and the display displays output information of the estimator;
a wireless network, disposed between the front platform and the rear platform, for transmitting the output signal of the front platform to the signal receiver of the rear platform; and
an error model, which is created in one of the front platform and the rear platform and is connected to the CPU or the estimator.

6. The augmented navigation system according to claim 5, wherein the inertial detection device comprises an accelerometer, an electronic compass and a gyroscope connected to the CPU.

7. The augmented navigation system according to claim 5, wherein the error model is software, hardware or firmware for performing a discrete mathematical accumulation and/or an integration operation according to positioning data of the GPS receiver and detected data of the inertial detection device.

8. The augmented navigation system according to claim 5, wherein the wireless network comprises a GSM (Global System for Mobile Communication) network, a GPRS (General Packet Radio Service) network or a Zigbee network.

9. The augmented navigation system according to claim 5, wherein the rear platform is a computer or a server.

10. The augmented navigation system according to claim 5, wherein the estimator comprises a Kalman filter.
